(19) United States
(12) Patent Application Publication
(10) Pub. No.: US 2004/0128175 A1
(43) Pub. Date: Jul. 1, 2004

(54) Method for monitoring workplace safety

(76) Inventors: Gary Andrzejewski, Naperville, IL (US); Michael Cooke, Princes Risborough (GB)

Correspondence Address: Sun Chemical Corporation, 222 Bridge Plaza South, Fort Lee, NJ, 07024, US

(21) Appl. No.: 10/331,668

(22) Filed: Dec. 27, 2002

(51) Int. Cl. G06F 17/60

(52) U.S. Cl. 705/8

(57) ABSTRACT

The present invention is directed to a methodology for centralizing the process of maintaining a workplace safety and environmental program. The methodology implements an internal audit program comprising the steps of obtaining a commitment to participate in the audit program, performing a baseline audit and generating a score, logging the audit date, setting up an action plan after the audit report has been accepted by site management, setting up an action plan review, setting up a cross audit, and finally setting up subsequent audit dates. If all of the criteria are met, a certificate is awarded to the site.

### FIELD OF THE INVENTION

The present invention relates to a system for implementing and monitoring a workplace safety and environmental program.

### BACKGROUND OF THE INVENTION

Government regulatory bodies, such as the Occupational Safety and Health Administration (OSHA) in the United States of America, promulgate regulations and establish standards intended to control the safety of the workplaces provided by employers to their employees. OSHA develops guidelines and issues regulations for safety and health standards, and conducts inspections of workplaces for compliance with these standards. In instances of noncompliance, it issues citations and proposes penalties.

Most companies recognize that managing health and environmental risks is a fundamental business issue. With penalties for noncompliance and regulatory or third-party actions on the rise, environmental liabilities can have a serious effect on a company's bottom line. Environmental, Health and Safety legislation is changing at an increasing pace in most countries. The complexity of this legislation requires work sites to take special measures to ensure that they are in compliance at all times. From a Corporate and Company standpoint, it must show a commitment to and vigilance in ensuring that its sites offer safe and healthy working conditions, that its processes minimize environmental pollution, and that it does not fall short in complying with the law.

Implementation of a workplace safety and environmental program can be quite time consuming. A search must be conducted for the various governmental regulations and standards, which impact workplace safety and workplace environment. The development of a workplace safety and environmental program usually also requires the accumulation and the maintenance of numerous forms. Once the program is developed, it must be maintained in order to ensure continuing compliance with applicable governmental regulations and standards.

Responsibility for the development and maintenance of the workplace safety and environmental program may be delegated to numerous persons, may be decentralized, and may not be clearly defined. The forms created during both the development and the maintenance of the safety and environmental program typically are filled out by numerous persons, and are stored in numerous locations within a workplace, which can make their retrieval difficult. Workplaces are frequently “audited” to ensure that the employer is in compliance with the applicable governmental regulations and standards, and if the forms and records used in the safety and environmental program are decentralized, it may be extremely difficult for the employer to prepare for an audit.

Given the hectic pace of site life, it is necessary to set aside time specifically to take a focused look at Health, Safety, and Environmental issues on a regular basis. One way of achieving this is to evaluate work place safety through routine “audits” i.e., monitoring of the work place/site, by focusing on specific areas as required or general audits covering most aspects of the operation. The audit's finding can: a) provide a review of Health, Safety, and Environmental strengths and weaknesses and provide local management with this information; b) it helps in drawing up action plans to address weaknesses, allowing improvements plans to be approximated in cost and properly budgeted for the coming year. This is preferable to being given very short notice to improve (or fined by the enforcement agency); c) an auditor from outside the site team may be able to bring experience from other sites to solve problems and may be able to offer a more objective view without being affected by the day to day issues of the site; d) the existence of an organized audit system helps to demonstrate to outside bodies that the company is acting responsibly in its efforts to ensure operations comply with the law.

The use of internal and external audits as part of an audit program is beneficial. Internal audits may be able to focus in depth on known or perceived “trouble” spots. ON the other hand, external auditors benefit from a “fresh look” at the site without any preconceived notions. To maximize the benefit of internal audits, it is good practice to vary the persons auditing a particular part of the site, to try and encourage a “fresh look” at the site periodically. Corporate audits offer a more independent view of operations. To maximize the benefits of these audits, corporate auditors rely heavily on assistance given by site employees/management. Action plans should be agreed upon to tackle issues raised in the audit report, setting out responsibilities for dealing with actions and a realistic time frame.

At large sites, a team of auditors can be rotated around different sections of the site. Audits will comprise an examination of management systems including essential documentation, operating procedures and how they are put into practice, training programs, accident prevention policies, as well as a site walkabout inspection. At the end of the audit, the auditor will hold a brief meeting with the site manager to give a preliminary verbal report on the audit. Particular areas of difficulty can be discussed at this point. Reports, following audits will be issued firstly to the site manager in draft form. An opportunity will be given to site management to comment on any items before the final report is issued to the site manager, the general manager for that site, the person the general manager reports to, or the business group's managing director, and the other members of the company's board.

A daily or weekly checklist can be a useful tool in ensuring high standards of health, safety and environment. Checklists not only help to focus people on specific issues but can be used to document status of those issues. A more detailed look at the site should be carried out at least every 3 months. These monthly/quarterly audits should be carried out at least twice a year by the Site Production Director and/or Site General Managers. Both Internal and External audits should lead to action plans. Corporate audit plans will be reviewed on a regular basis, and progress and reports will be issued to the Board of Directors.

The present invention solves the problem of decentralizing the audit process by providing a method for centralizing the process of maintaining a workplace safety and environmental program.

### SUMMARY OF THE INVENTION

The present invention is directed to a methodology for centralizing the process of maintaining a workplace safety and environmental program. The focus is on implementing an internal audit program comprising the steps of obtaining a commitment to participate in the audit program, performing a baseline audit and generating a score, logging the audit date, setting up an action plan after the audit report has been accepted by site management, setting up an action plan review, setting up a cross audit, and finally setting up subsequent audit dates. During the audit process, the site is required to submit monthly accident statistics, so that sites exceeding goals for the Injury Index are automatically highlighted. In addition, during the audit process, quarterly and annual performance indicators data is submitted, and this data is used to benchmark site performance. If all of the criteria are met, a certificate is awarded to the site.

### BRIEF DESCRIPTION OF THE DRAWINGS

A more complete understanding of the method of the present invention may be obtained by reference to the following Detailed Description when taken in conjunction with the accompanying drawing wherein:

FIG. 1 illustrates a flow chart of an audit procedure of the instant invention.

### DETAILED DESCRIPTION OF THE INVENTION

The present invention will now be described more fully hereinafter with reference to the accompanying drawing, in which a preferred embodiment of the invention is shown. This invention may, however, be embodied in many different forms and should not be construed to be limited to the embodiment set forth herein; rather, the disclosed embodiment is provided so that the disclosure will be thorough and complete, and will fully convey the scope of the invention to those skilled in the art.

The following definitions are provided in order to facilitate a thorough understanding of the present invention:

Baseline Audit means the first audit performed based on which a site's progress in attaining goals is measured.

Audit Date means the date on which audit is performed.

Audit Evaluation Worksheet means the worksheet used during audit procedure for the purposes of documenting the audit.

Action Plan means the plan which addresses any improvements or corrections that need to be made to a site's safety and environmental profile.

Corporate Audit means the audits performed by Company or Corporate personnel.

Cross Audit means the audits performed by persons other than the Corporate Audit team.

Injury Index means the measure of the frequency of site accidents and their severity. The Injury Index is calculated to be the square root of a number which is calculated to be the All accident rate times the Total Days Lost times 50,000, divided by the Hours Worked, and then divided again by 40;

All accident rate is calculated to be the sum of all accidents resulting in lost days times 100,000 and the resulting number divided by the hours worked;

Total Days Lost means the number of days where a person is unable to carry out his/her normal work due to a work-related injury. This is calculated to the nearest half day of lost work.

Hours Worked means the total number of hours employees worked, including over time.

The purpose of the audit procedure is to ensure that work sites are safe places to work in and visit, and that environmental protection is of the highest practicable standard. The audits/inspections should also ensure that sites operate in compliance with all relevant local legislation. Without limiting the scope of the invention, a preferred embodiment of the invention would be carried out as follows:

Step 1: Local site management shall set up a Safety & Environmental audit program for their site. A checklist is generated based on the type of site and safety concerns relevant to the site and should subsequently be reviewed annually by the safety committee to ensure that they are still relevant. The make-up of the audit team and frequency of audits/inspections should reflect the hazards present and the requirements below.

Step 2: Daily or weekly checks should be carried out by site personnel and documented. Example 1 provides an example of such a checklist. More detailed site inspections, to check on general safety and environmental standards, should take place at least every three months. Example 2 provides an example of a checklist that can be used for this purpose.

Step 3: The site manager shall conduct one inspection/audit at least once every twelve months. These may be combined with one of the quarterly inspections/audits.

Step 4: Inspections/audit findings shall be documented. Senior site management should review audits/inspections and determine the appropriate action required at or before the next site safety committee meeting.

Step 5: The use of a checklist (see Examples 1 and 2) is recommended. The checklists should be reviewed annually by the safety committee to ensure that they are still relevant.

Step 6: Corporate audits may also be conducted by one or members of the Corporate audit team to give a semi-independent overview of safety and environmental standards at sites.

Step 7: Audit reports generated by Corporate audits will be circulated to the relevant persons including, but not limited to, the site general manager, the relevant managing director, and the safety and environmental manager, following approval of the draft report by the site management.

Step 8: Following a Corporate audit, an action plan shall be submitted to the safety and environmental manager. The action plan shall be reviewed and updated on a regular basis.

Step 9: External third party audits may be arranged by the safety and environmental manager in conjunction with the relevant general manager.

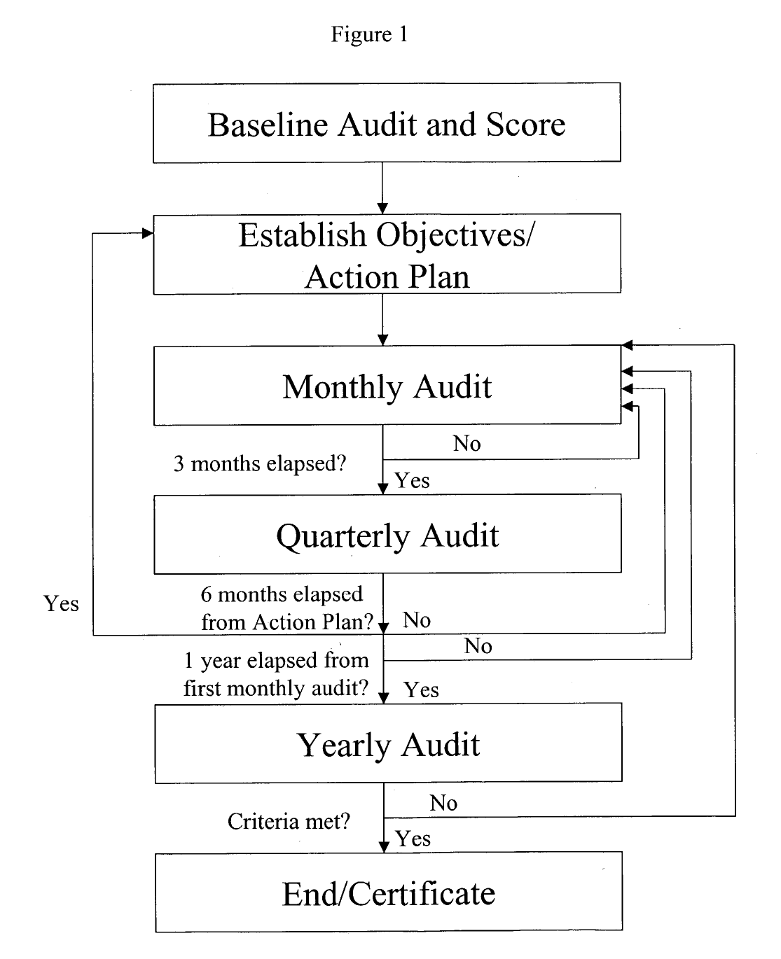

FIG. 1 illustrates a flow chart of an audit procedure pursuant to the teachings of the instant invention. Prior to the commencement of an audit procedure, the site management commit themselves to the workplace safety program and its goals. A baseline audit of the workplace is conducted and a score is generated using the audit evaluation worksheet. At the time of the baseline audit, it is emphasized that the site is required to submit monthly accident statistics. Sites exceeding performance goals for the Injury Index are automatically highlighted. Following the baseline audit, the site management agrees on the objectives of the workplace safety program and goals to be implemented at a particular site. The audit date is logged in and an action plan is generated one month after the audit report is accepted by the site management. At the time when the action plan is generated, quarterly and annual performance indicators are also submitted, to provide the basis for analyzing site performance according to the goals outlined in the action plan. Six months following the audit date, the site is required to submit an updated action plan using the audit evaluation worksheet. At this time, the site's performance data are used to benchmark the site's performance in accordance with the quarterly and annual performance indicators submitted. A cross audit and subsequent audits follow at intervals agreed upon by site management. During the subsequent audits, the site's performance is compared with established criteria. If all criteria are met, a certificate is awarded to the site.

The methodology for monitoring the safety of a workplace of the present invention is further illustrated by the following non-limiting examples.

### EXAMPLE 1

A methodology for monitoring the safety of a chemical manufacturing workplace is set forth below:

Daily/Weekly Checklist

1 Fire extinguisher and fire points

sufficient

maintained in working order

2. Fire exits clear

3. Waste containers-stored properly

Waste containers-no leaks

Waste containers-labeled clearly

4. Materials storage-tidy

Materials storage-no leaks

Materials storage-correct segregation

Materials storage-labeling OK

Materials storage-pallets undamaged

Materials storage-safe stacking

Racking-safe, not damaged

5. Bulk storage-valves, pipes in good order

Bulk storage-pumps, joints not leaking

Bulk storage-bund walls undamaged

Bulk storage-bund rainwater drainage OK

Bulk storage-earthing wires in place

Bulk storage-tank marking correct

6. Flammable materials stored and handled correctly

7. Housekeeping general

8. Machines/Production facilities;

safety guards in place

pumps not leaking/pump area clean

joints/valves not leaking

no damage or exposed wires

gauges (e.g., pressure, temperature) OK

no unusual situations (e.g., floors, building)

ventilation functioning OK

emergency equipment (e.g., showers) OK

9. Effluent treatment plant:

dosing chemicals OK

sensors in place and functioning

pumps and pipelines OK

storage and mixing vessels OK

10. Health matters:

Personal protective equipment (PPE)

PPE being worn correctly

No new chemicals on site without an appropriate health risk assessment

Health surveillance being carried out where appropriate

11. Site Security:

no evidence of attempted force entry

fences and gates secure

no unusual observances

### EXAMPLE 2

A methodology for monitoring the safety of a manufacturing and warehouse workplace is set forth below:

Monthly/Quarterly Checklist

1. General Housekeeping:

Are all aisles clear of trip hazards

Are mezzanine gates closed when not in use

Are stairways clear and free of debris

Are spills cleaned up immediately

Are floors clean

Are used cleaning rags kept in self-closing containers

Is housekeeping acceptable throughout the facility

2. Fire Safety:

Is access to all extinguishers

Are extinguishers properly mounted on wall

Are extinguishers fully charged and properly maintained

Are fire doors equipped with fusible links

Are fire doors clear and in proper working order

Is 50 cm clearance provided between sprinkler head and the materials stored in the top level of racks

Is main water supply valve for sprinkler system locked “OPEN” or alarmed

Are all earthing straps/clamps in good condition

Have the earthing straps/clamps been tested in the last 6 months

Is low level ventilation operational in applicable production and storage areas

(24 hrs/day-7 days/week)

Is smoking restricted to designated areas

Are flammable liquids stored in proper areas

Are earthing/grounding procedures followed when transferring flammable liquid (earthing should be provided between dispensing and receiving vessels and from receiving vessel to earthing connection)

Are all containers of flammable liquid kept covered when not in use

3. Exits:

Are all exits clear

Do exit doors open freely

Are all exit signs properly illuminated

Exit/emergency lights operable (every light must be tested)

4. Personal Protection:

Do all eyewash stations operate properly (Mixers, battery charger, soak tank/tub washer)

Is access to eyewash stations clear and are they kept clean

Is water solution in eyewash bottles within the expiration date

Is eye protection worn when required

Are respirators worn when required

Are respirators stored in a designated area when not in use and kept in a clean, sanitized condition

Are gloves worn when required

Is hearing protection worn when required

Is protective equipment worn when employees are working on the soak tank/tub washer (glove, goggles/faceshield, apron)

5. Material Handling:

Are forks on fork trucks lowered on the floor when truck is not in use

Are forks in good condition

Are tires in good condition

Is truck horn functional

Do fork brakes operate properly

Does fork truck mast operate properly (smoothly, no jerking action)

Do only trained personnel operate fork trucks

Do hoist hooks have safety clips

Are hoist chains/cable in good condition

Are proper manual lifting procedures followed (body close to load, lift with legs, back straight, etc.)

6. Inventory Storage:

Are products and raw materials labeled with appropriate hazard warning labels

Are pallet racks undamaged and secured to the floor

Are palletized loads located in rack storage stable

Are pallets in good condition

Are containers in good condition with no leaks

7. Maintenance Issues:

Are electrical cords and plugs to fans, mixers, etc. maintained

Are electrical cabinets closed

Are motors clean and free of grease, dirt and/or ink build-up

Have preventative maintenance activities been scheduled/conducted (as applicable)

8. Machine Guarding:

Are belt guards in place on mixers and compressors

Are coupling guards in place on pumps

Are all mixers kept in the down position when not in use

Are all safety switches operable

Are eye protection shields in place on bench grinders

9. Ladders

Are ladders stable

Are side rails and step to step ladders, extension ladders and rolling ladders in good condition

Are rubber shoes in place on metal rolling ladders

Do wheels on metal rolling ladders lock in place

10. Office/Lab area

Are electrical outlets overloaded

Are file drawers closed when not in use

Are floors/aisle ways free of tripping hazards

Are chemicals properly stored in the lab

Is housekeeping adequate in offices and lab

11. Environmental

Are drums of hazardous waste stored in the designated accumulation and storage areas

Are all drums closed tightly when not in use

Is there any evidence of leakage

Are all drums of hazardous waste labeled

Are all drums in accumulation area labeled

Are weekly inspections being conducted and documented of the hazardous waste storage area

Is the waste skip closed when not in use

Is floor scrubber wash water being recycled or disposed of offsite through a registered waste disposal company

Is spill response equipment located in the designated areas and only used for spill response

Are lids in place on mixers and tubs of inks as required to minimize VOC emissions

12. First Aid

Are first aid supplies adequate

Is an accident/incident (including near misses) log maintained

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A methodology for monitoring the safety of a workplace, said methodology comprising the steps of:
establishing a safety program for said workplace;
establishing a checklist for said safety program;
conducting a safety check according to said checklist;
calculating the injury index for said workplace by the formula {[All accident rate (Total days lost x 50,000)/Hours worked]/40};
documenting the findings of said safety check;
logging the date when said safety check is conducted;
submitting performance indicators; and
initiating an action plan based on said findings of said safety check.

2. The methodology according to claim 1, wherein said monitoring is performed by an audit.

3. The methodology according to claim 1, wherein said safety check is carried out at least once a day.

4. The methodology according to claim 1, wherein said safety check is carried out at least once a week.

5. The methodology according to claim 1, wherein said safety check is carried out at least once every three months.

6. The methodology according to claim 1, wherein said safety check is at least once every twelve months.

7. The methodology according to claim 1, comprising the additional step of a baseline audit.

8. The methodology according to claim 7, wherein said baseline audit uses an audit evaluation worksheet.

9. The methodology according to claim 1, wherein said safety program monitors workplace areas selected from the group consisting of fire extinguishers, fire exits, emergency exits, fire safety, waste containers, materials storage, materials handling, racking, bulk storage, flammable materials, general housekeeping, machines, machine guarding, production facilities, effluent treatment plant, health matters, site security, personal protection, inventory storage, maintenance issues, ladders, office areas, laboratory areas, environmental issues, hazardous waste, and first aid.

10. The methodology according to claim 1, wherein said checklist is selected from the group consisting of a daily checklist, a weekly checklist, a monthly checklist, and a quarterly checklist.

11. The methodology according to claim 1, wherein said findings are documented in an audit evaluation worksheet.

12. The methodology according to claim 1, wherein said findings are reviewed by workplace management.

13. The methodology according to claim 1, wherein said findings are used to create an action report.

14. The methodology according to claim 1, comprising the additional step of a cross audit.

15. The methodology according to claim 1, comprising the additional step of a subsequent audit.

16. The methodology according to claim 1, wherein said performance indicators are selected from the group consisting of daily performance indicators, weekly performance indicators, quarterly performance indicators and annual performance indicators.
